(19) United States
(12) Patent Application Publication
(10) Pub. No.: US 2009/0077415 A1
(43) Pub. Date: Mar. 19, 2009

(54) CONTROL FLOW PROTECTION MECHANISM

(76) Inventors: Andrew Kay, Oxfordshire (GB); Anthony Kirby, Oxfordshire (GB); John Nonweiler, Oxfordshire (GB)

Correspondence Address: BIRCH STEWART KOLASCH & BIRCH, PO BOX 747, FALLS CHURCH, VA, 22040-0747, US

(21) Appl. No.: 12/280,672

(22) PCT Filed: Feb. 26, 2007
(86) PCT No.: PCT/JP2007/054115

§ 371 Date: Aug. 25, 2008

(30) Foreign Application Priority Data
Feb. 27, 2006 (GB) 0603861.6

(51) Int. Cl. G06F 11/20

(52) U.S. Cl. 714/5; 714/E11.071

(57) ABSTRACT

A method is provided of protecting a program executing on a device at least to some extent from execution flow errors caused by physical disturbances, such as device failures and voltage spikes, that cause program execution to jump to an unexpected memory location. The executing program follows an execution path that proceeds through a plurality of regions (B′[m], B′[f]). A first check value (wisb) is provided at a randomly accessible memory location. It is determined at least once (e.g. in TERM[m]) in at least one region (B′[m]) whether the first check value (wisb) has an expected value (s[m]) for that region (B′[m]). The first check value (wisb) is updated (e.g. in “set-up for call to f”), as execution passes from a first region (B′[m]) into a second region (B′[f]) in which such a determination is made, so as to have a value (s[f]) expected in the second region (B′[f]). An error handling procedure is performed if such a determination is negative.

The present invention relates to a control flow protection mechanism for a computing device.

A CPU based device operates on its input using a stored program and stored data to produce output. The program consists of discrete instructions that are executed by the CPU in a sequence dictated by the logic of the program, as designed by the programmer. A CPU has a concept of Program Counter (or PC) that indicates the address in the store of the next instruction to be fetched or executed. The Program Counter may be identified with a hardware register, but there are other implementations. As a result of executing an instruction, the Program Counter is updated by the CPU to point to the next instruction, which is usually at the storage location just above the previous instruction in the store (in the case of a simple or “non-branching” instruction), or else at a different location entirely in the case of a “branching” jump or call type instruction. Interrupts are ignored in this model.

Software running on a secure device must be protected against a number of classes of attack. One such class is the “fault” attack in which the device is made to misbehave by manipulating it in some unconventional way, with the hope that ensuing misbehaviour of the device causes an effect in the attackers favour. In one kind of fault attack, an attacker may introduce a transient voltage spike (or “glitch”) into the power supply or I/O ports, or flash a bright light into the CPU IC, which can (amongst other effects) cause the Program Counter to change to an unexpected address and continue executing code from there. Thus the program is executed in a sequence unanticipated by the programmer. With perseverance, the attacker may find a suitable glitch to cause the device to reveal secret information, or circumvent security checks, and so on. Although it seems unlikely that this could work, it is in fact a practical attack technique.

For example, the programmer may provide a function “make-credit( )”, to be called only when security clearance (such as a PIN check and parameter check) has been obtained. If the attacker can force the Program Counter to jump to make-credit( ) from some other place in the code then he will cause credit to be added without the PIN being checked.

Another similar attack might result in secret internal data being copied erroneously to the device's output channel. Once a device is compromised in this way it might also be possible to use the attack parameters to replicate the attack on other similar devices (or the same device at another time).

Similar considerations apply to inadvertent temporary modifications to the Program Counter, for example when caused by cosmic rays or other accidental occurrences such as failures of parts of the device. Safety-critical and mission-critical systems are at risk too, not only secure systems.

All of the above-mentioned types of glitches and other physical factors affecting the device, such as device failures, that may cause program execution to jump to an unexpected memory location are referred to herein generally as “physical disturbances”.

U.S. Pat. No. 5,274,817 (Caterpillar Inc.) discloses a method for executing subroutine calls in which a check address is stored on the stack prior to a subroutine call, which is confirmed before the subroutine returns to the calling routine. This provides some degree of protection against accidental disturbances that might cause errors in the Program Counter value. However, the method disclosed does not prevent a call to the wrong function in some circumstances; for example, if execution jumped from just before a stack push operation setting up a protected call to an intended function to just before a stack push operation setting up a protected call to an unintended function, then no error would be recognised in the called (unintended) function.

JP 4111138 (Fujitsu) discloses the use of a global model to indicate what transitions in Program Counter are allowed, relying on a hardware detection system.

EP 0590866 (AT&T) discloses a computing technique that provides fault tolerance rather than fault detection.

U.S. Pat. No. 5,758,060 (Dallas Semiconductor) discloses hardware for verifying that software has not skipped a predetermined amount of code. The technique involves checking a hardware timer to determine whether a predetermined data operation occurs at approximately the right time.

GB 1422603 (Ericsson) discloses a technique that checks the time spent executing sections of code to detect faults.

U.S. Pat. No. 6,044,458 (Motorola) discloses a hardware technique for monitoring program flow utilizing fixwords stored sequentially to opcodes.

U.S. Pat. No. 5,717,849 (IBM) discloses a system and procedure for early detection of a fault in a chained series of control blocks. A method is disclosed for checking that each unit of work (or “block”) in a program execution is correctly associated with the right program (so that unrelated blocks are not executed). It does this by comparing tags (that are embedded as data in the blocks) when the blocks are loaded by the operating system (eg from a remote storage device), not as part of the program execution. The protection offered would be complementary to that of the present invention.

The use of a “watchdog” timer is well known in the prior art. This is a hardware device that is reset at intervals by the program. If the program fails in some way (e.g. during an attack), and does not reset timer soon enough, the watchdog will time-out and appropriate action can be taken. However, special hardware is required, and detection is rather coarse so that software reaching any reset point will pacify the watchdog.

It has been previously considered that program can use the CPU clock (cycle counter) to determine whether a glitch has occurred. After a glitch, an action may complete sooner (or later) than was predicted before it started. However, such a method is generally not suitable for checking code that takes a data-dependent or environment-dependent length of time to complete.

Another previously-considered method is to provide an executable model of the possible evolutions of a program execution state. As the program executes, it informs the model component of its state. If the model determines that the program has reached a state that it should not have done, then it can assume that an attack is in progress and can take action. However, such a model is potentially expensive to develop, and the model is likely to be inaccurate (excessively permissive), or else large and inefficient.

According to a first aspect of the present invention, there is provided a method of protecting a program executing on a device at least to some extent from execution flow errors caused by physical disturbances, such as device failures and voltage spikes, that cause program execution to jump to an unexpected memory location, the executing program following an execution path that proceeds through a plurality of regions, and the method comprising: providing a first check value at a randomly accessible memory location; determining at least once in at least one region whether the first check value has an expected value for that region; updating the first check value, as execution passes from a first region into a second region in which such a determination is made, so as to have a value expected in the second region; and performing an error handling procedure if such a determination is negative.

The method may comprise performing such a determining step before at least some operations of the program having a critical nature.

The method may comprise performing such a determining step before at least some of the check value updating steps.

The method may comprise performing such a determining step before at least some operations of the program that update a persistent storage of the device. The method may comprise performing such a determining step before at least some operations that cause data to be sent outside the device, or outside a protected area of the device.

The method may comprise providing a second check value at a randomly accessible memory location, and, where a region comprises a functional unit of code called from a calling region and returning execution to a returning region, updating the second check value before execution passes out of the unit so as to have a final value expected for the unit, and determining whether the second check value has the expected final value after execution passes out of the unit and before execution returns to the returning region.

The returning region may be the same as the calling region.

The second check value may be the same as the first check value, using the same randomly accessible memory location, and the method may comprise determining whether the second check value has the expected final value before the first check value is updated to have the value expected in the second region.

The method may comprise, as execution passes into such a first region where such an updating step is performed before execution passes into such a second region, updating the first check value so as to have a value expected in the first region.

The method may comprise updating the check value in a manner such that, once the check value assumes an unexpected value, it is likely to retain an unexpected value with subsequent such updates.

The method may comprise updating the check value based on its expected value for the second region and its expected for the first region in a manner such that the updated check value has the expected value for the second region only if it has the expected value for the first region before the update.

The method may comprise updating the check value by effectively applying a first adjustment derived from the expected value for the first region and a second adjustment derived from the expected value for the second region, the first adjustment using an operator that has an inverse relationship to that used for the second adjustment.

The method may comprise applying the first and second adjustments together by computing an intermediate value derived from the expected value for the first region and the expected value for the second region, and applying a single adjustment to the check value derived from the computed intermediate value.

The intermediate value may be precomputed, during the course of compilation.

The method may comprise applying the first and second adjustments separately to the check value.

The operator for the first adjustment may be a subtract operation and the operator for the second adjustment may be an addition operation.

The operator for the first adjustment may be an exclusive-or operation and the operator for the second adjustment may be an exclusive-or operation.

The respective expected values for at least some regions or functional units may be retrieved directly from the program code.

The method may comprise storing the respective expected values for at least some regions or functional units at different memory locations, and retrieving the expected value for a region or functional unit from the appropriate memory location when required.

At least some expected values may be random or pseudo random numbers.

At least some expected values may be derived from an entry point memory location of their corresponding respective regions or functional units.

The method may comprise deriving the at least some expected values using a hashing technique.

The method may comprise providing a third check value at a randomly accessible memory location, and, where a region comprises a functional unit of code called from a calling region and returning execution to the calling region, updating the third check value before execution passes into the functional unit so as to have a value related to that call, and determining, after execution returns from at least one such functional unit, whether the third check value has the value related to that call.

The method may comprise performing the third check value determining step before execution passes back into the calling region.

The method may comprise updating the third check value by applying an adjustment of an amount associated with that call, and determining whether the third check value retains the value related to that call after execution returns by determining whether reversing the adjustment by the same amount would return the third check value to its value prior to the pre-call adjustment.

The method may comprise updating he third check value to return it to its value prior to the pre-call adjustment.

The steps may be carried out by instructions included in the program before execution. Program execution may be controlled by a Program Counter.

The device may comprise a secure device.

The device may comprise a smart card.

According to a second aspect of the present invention, there is provided a method of protecting a program to be executed on a device at least to some extent from execution flow errors caused by physical disturbances, such as device failures and voltage spikes, that cause program execution to jump to an unexpected memory location, the program following when executed an execution path that proceeds through a plurality of regions, and the method comprising transforming the program so as to include the steps of: providing a first check value at a randomly accessible memory location; determining at least once in at least one region whether the first check value has an expected value for that region; updating the first check value, as execution passes from a first region into a second region in which such a determination is made, so as to have a value expected in the second region; and performing an error handling procedure if such a determination is negative.

The program may be specified in a high level programming language such as the C programming language.

The method may comprise compiling the program to produce machine code for execution directly by the device.

According to a third aspect of the present invention, there is provided a device loaded with a program protected at least to some extent from execution flow errors caused by physical disturbances, such as device failures and voltage spikes, that cause program execution to jump to an unexpected memory location, the executing program following an execution path that proceeds through a plurality of regions, and the device comprising: means for providing a first check value at a randomly accessible memory location; means for determining at least once in at least one region whether the first check value has an expected value for that region; means for updating the first check value, as execution passes from a first region into a second region in which such a determination is made, so as to have a value expected in the second region; and means for performing an error handling procedure if such a determination is negative.

According to a fourth aspect of the present invention, there is provided a program which, when run on a device, causes the device to carry out a method according to the first or second aspect of the present invention.

According to a fifth aspect of the present invention, there is provided a program which, when loaded into a device, causes the device to become one according to the third aspect of the present invention.

The program may be carried on a carrier medium. The carrier medium may be a transmission medium. The carrier medium may be a storage medium.

Reference will now be made, by way of example, to the accompanying drawings, in which:

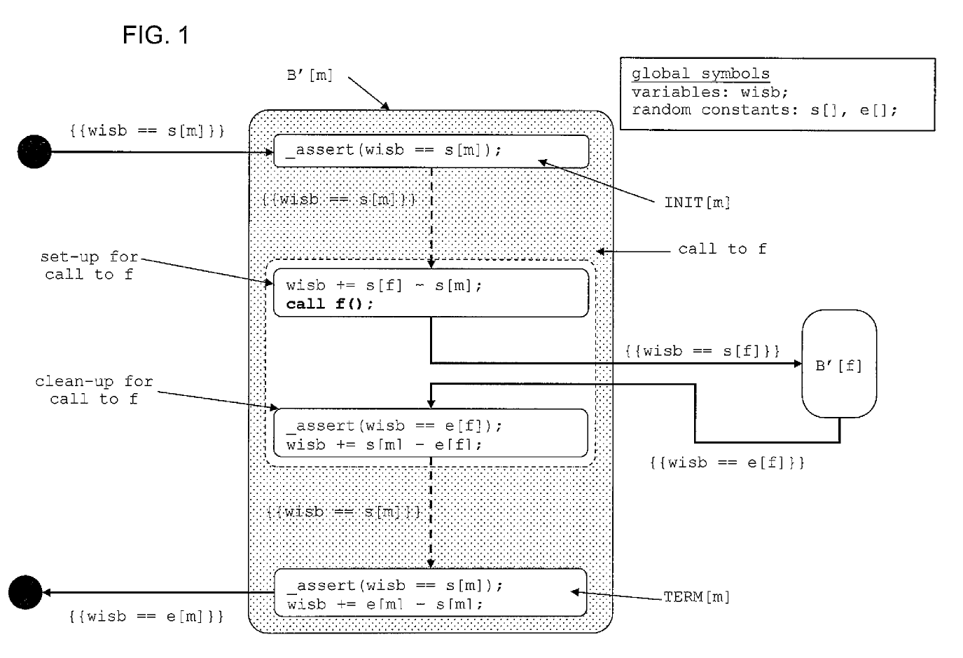

FIG. 1 illustrates operation of a first embodiment of the present invention;

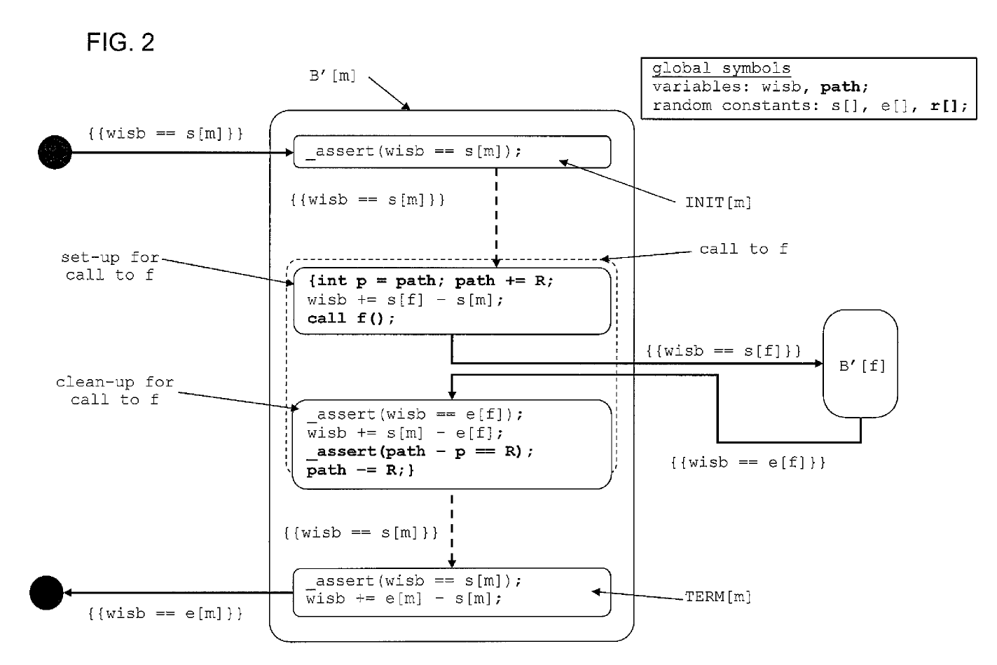

FIG. 2 illustrates operation of a second embodiment of the present invention;

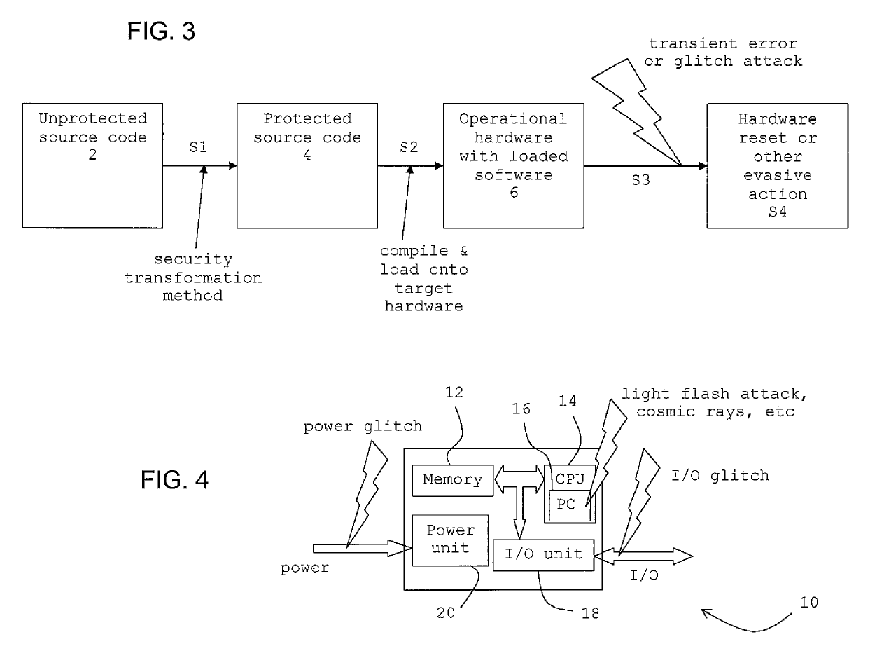

FIG. 3 is a block diagram illustrating various stages in one possible scheme making use of an embodiment of the present invention; and

FIG. 4 is an illustrative block diagram showing a device programmed to execute a protected program according to an embodiment of the present invention, and illustrates examples of the various types of attack points on such a device.

Taking account of the previous-considered methods described above, an embodiment of the present invention proposes a software flow control check to help ensure that, if the Program Counter reaches a certain point in the code by a route which is not anticipated by the programmer, then the CPU detects this and may take protective action (such as shutting down the device or performing any other type of error handling routine).

Embodiments of the present invention will be described below with reference to source code written in C, or a simplified subset thereof.

In particular, and in accordance with the usual C language syntax, “=” is used to denote assignment, “+=” to denote incrementing assignment, and “===” to denote a test for equality.

The term “function” is used to denote a piece of code which stands as a unit. In normal software engineering practice, a function has a name and a well-specified behaviour. In the C language, this is indeed called a function, but in some computer languages the terms “subroutine”, “procedure” or “method” are used for the same concept.

The terms “fault” and “error” are used in a generally interchangeable fashion, to denote both deliberately and accidentally induced misbehaviour of the system.

The syntax “[ ] ” is used to denote subscripts, for example r[c], s[c] e[c].

A method embodying one aspect of the present invention comprises transforming source code to make it more secure from attacks that modify the Program Counter.

In such a method, the program code can be considered to be divided into regions, with each region, c, being given a random but fixed value r[c]. A global variable wisb is defined with the intention that wisb==r[c] whenever the Program Counter points to code in region c. Whenever the Program Counter could correctly move from a region c to a new region c′, the transformation inserts a statement to transform the previous value of wisb to the new value, r[c′]. The code within a region may be optionally transformed to check that the value of wisb is correct (and take some appropriate action if it is not). Any flow of control between regions which is not matched by an assignment to wisb can then potentially be detected.

Rather than simply assign wisb=r[c′], it is preferable to set wisb to its previous value plus the value of r[c′]−r[c]. With this, and assuming the old value was r[c], the new value will be r[c]+(r[c′]−r[c]), which is equal to r[c′]. However, if due to some fault the old value was wrong (i.e. not equal to r[c]), then the new value will also be wrong, and by the same amount. It will also continue to be wrong (except by chance) for the remainder of the execution. Therefore, even if the value is not checked immediately, it can be caught later.

It is considered in this way that wisb has the “error propagation” property: once it is incorrect it will stay incorrect (with high probability). This is a useful property for security and for detecting errors.

### FIRST EMBODIMENT

A first embodiment of the present invention will now be described with reference to FIG. 1, which shows a protected function m calling a protected function f.

Suppose there is a program (or subprogram) P that is to be protected.

It is decided which parts of P it is desired to protect. In this embodiment it is decided to protect only whole functions. It is convenient then to take C={c1, c2, . . . cn} to be the names of all the functions defined in P which are to be protected. The transformation utility should know the protection status of both the caller the called in order properly to follow the protection protocol. Assume that at least one function is to be protected and that an unprotected function may not call a protected function.

Assume that there is provided a function _assert (x) which accepts an input x, and if x is true simply returns to the caller. If x is false it causes some kind of fault alert function or error handling routine to operate (such as resetting the device). The function _assert ( ) in general would not be one of the functions to be protected in an embodiment of the present invention; in many cases it would be a low-level call provided by the platform.

For each c in C, two values s[c] and e[c] are defined, where “s” and “e” stand for “start” and “end” respectively. For security, s[c] and e[c] should preferably be chosen randomly, ranging over the entire set of possibilities for their (integer) datatype. To prevent replication of attacks, s[c] and e[C] would preferably be generated randomly each time the device is started. However, for the purpose of this embodiment it is assumed that they are constants.

A global variable wisb is declared with the same datatype as the values of s[c] and e[c], and give it an initial value s[main], where “main” is the outermost function defined in P (the intended sole entry point for P). In the C programming language this function is indeed called “main”. Because of the conditions described earlier, it is guaranteed in this embodiment that main is a protected function.

For each c in c the function c is modified by replacing its body code B [c] with modified code B′ [c], where B′[c] is defined as follows.

(The final TERM [c] can be omitted if every possible execution path through BB[c] finishes with a return statement).

In the absence of a fault, if wisb is equal to s[c] when B′[c] begins executing then it will be equal to e[c] when (and if) it terminates. Moreover, whenever B′[c] calls a (protected) function f, the value of wisb will be s[f] when f starts and e[f] when f returns. In FIG. 1 the expressions in double braces {{ }} denote values which are intended to be true in the absence of a fault; these expressions are inserted to aid in an understanding of FIG. 1 and are not to be considered part of the code.

It is to be noted that the checking assertions are optional, to the extent that once wisb is incorrect (due to a fault) it is very likely to remain incorrect, since no command will automatically correct it, in view of the error propagation property. Therefore it is only necessary to check occasionally for an error. For example, for a security-centred application, a minimum set of checks might be checking just before: each security-critical operation; each operation which updates the persistent store; and each I/O operation which sends data to the outside world. It is allowable to insert more or fewer assertions, as required by the particular application.

An example will now be provided of the transformation applied to a simple program.

In this example, suppose that function “main” calls function “docredit”. The function “print” is generic and defined by the system, so it is not considered necessary here to protect it.

The unprotected code is:

```
main(pin, amount) {
    if (pin != test) return;
    print(docredit(x));
}
int docredit(int x) {
    balance = balance + x;
    return balance;
}
```

The above code can first be transformed to the following, so that the call to “docredit( )” is not inside the call to “print( )”:

```
main(pin, amount) {
    int y;
    if (pin != test) return;
    y = docredit(x);
    print(y);
}
int docredit(int x) {
    balance = balance + x;
    return balance;
}
```

Then the rest of the transformation is applied. For explanatory purposes, pre-processor constants will be defined called sMAIN to implement s[main], eMAIN for e[main] and so on. It will be appreciated that the random numbers could instead be interpolated at the point of use, but this would be harder for the reader to follow.

| // constants for each function | |
|---|---|
| // name (randomly generated) | |
| #define sMAIN 56769 | |
| #define eMAIN 15637 | |
| #define sDOCREDIT 9493 | |
| #define eDOCREDIT 41322 | |
| int wisb = sMAIN; | |
| main(pin, amount) { | |
| int y; | |
| _assert(wisb==sMAIN); // INIT[MAIN] | |
| if (pin != test) | |
| {wisb += eMAIN − sMAIN; return;} | // handling |
| | // return |

```
    // handling function call:
    {wisb += sDOCREDIT − sMAIN;
    y = docredit(amount);
    _assert(wisb == eDOCREDIT);
    wisb += sMAIN − eDOCREDIT;}
    _assert(wisb==sMAIN);  // added check
    print(y);
    wisb += eMAIN − sMAIN;  // TERM[MAIN]
}
docredit(int amount) {
    _assert(wisb==sDOCREDIT]);  // INIT[DOCREDIT]
    balance = balance + amount;
    {wisb += eDOCREDIT − sDOCREDIT; return;}
    // no TERM required (return is always used)
}
```

It is to be noted that many compilers would simplify the constant expressions (“constant folding”) for more efficient execution. For example “wisb+=eMAIN−sMAIN;” can be reduced to “wisb+=−41132;”. This does not affect the security. It is also to be noted that an extra assertion was added just before print, to catch any attempt to perform accidental printing of secret data.

### SECOND EMBODIMENT

A second embodiment of the present invention will now be described with reference to FIG. 2.

One possible limitation with the first embodiment is that, whenever a function f returns, the value of wisb must be e[f]. However, f may be called from more than one point in the source code (it is said that f is a “multi-caller” function), and so the scheme does not protect against a glitch which makes f return to a wrong caller. For example, if m1 and m2 are both designed to call f, a glitch might cause f to return to m2 even when it is called from m1. The value of wisb would be the same in each case, e[f] so the protocol of the first embodiment cannot detect the fault.

To add a second layer of protection, an extra variable path is introduced to the global state in the second embodiment and initialised, preferably to a random value, in the second embodiment.

As before, when c is called, it is ensured that {{wisb==s[c]}}, and when c terminates it is ensured that {{wisb==e [c]}} (as for FIG. 1, in FIG. 2 the expressions in double braces {{ }} denote values which are intended to be true in the absence of a fault; these expressions are inserted to aid in an understanding of FIG. 2 and are not to be considered part of the code). In addition, before a function f is called (and before wisb is updated) a local copy p is stored of the value of path. Then path is changed in a known way by adding a (constant) random value R, where R is unique to a particular function call. After the function returns and wisb has been updated, it is determined whether the value of path-p is equal to R. Then path is restored by subtracting R again.

The region of protection of this measure is a superset of the region in which wisb is equal to s[f]. Recall that the wisb mechanism cannot distinguish such regions in case f is a multi-caller function. Therefore each such region throughout the code is given a different value (R) of path-p. If the function returns somehow to the wrong region then either wisb will be wrong or path-p will be wrong. As an alternative to having _assert (path−p==R) before the adjustment to path, it is possible to adjust path, with path−=R, before an _assert(path==p) statement.

Define INIT [c] and TERM[c] as before. Again, as before, convert function calls to the canonical form Y=F (X). For each such function call, create a constant random number R and replace the function call as follows:
{int p=path; path+=R;
wisp+s[F]−s[c]
Y=F(X);
_assert(wisb==e[F]);
wisb+=s[c]−e[F];
_assert (path−p==R);
path−=R;}

It is to be noted that it is not necessary to use this method on every function call. Only those deemed “at risk” (e.g. because they call a multi-caller function) need be modified. Other functions may use the method of first embodiment (or can be left totally unprotected).

The cost of this method over the first one is a single extra global variable, path, plus at most one local storage location, p, for each function that uses the method. The local storage p can be kept on the stack, with the advantage that only when the function it Before B′[c] runs, the construction guarantees that if there is no induced fault then wisb==s[c] is true. When B′[c] finishes, it ensures that wisb==e [c] is true, if there is no fault.

Define INIT[c] to be the statement “_assert (wisb==s[c]);”.

Define TERM[c] to be the statement “wisb+=e[c]−s[c];”.

B[c] is first rewritten to modify each internal call to a function which is to be protected. To make this as straightforward as possible, it is first supposed that each function call to be protected is written as a statement on its own, in the form “X=F(Y);” where X is an (optional) variable used to store the (optional) result of the function F with (optional) parameters Y. It is straightforward to make this the case if it is not already the case.

Replace each “X=F(Y)” by the statements:
{wisb+=s[F]−s[c]
X=F(Y);
_assert(wisb==e[F]);
wisb+=s[c]−e[F];}

Any “return X;” statements (where X is the optional return value) is also replaced by “{TERM[c]; return X;}”. This handles the case when B[c] finishes deliberately early. An alternative method would be to rewrite B[C] without using the “return” statement, though this would be more complex.

The modified fragment (i.e. B [c] with all function calls and return statements replaced as described above) will be referred to as BB [c].

Now define B′[c] to be “INIT[c]; BR[c]; TERM[c];”.

protects is active (or is waiting for a call to return to it) does it use storage. Alternatively each protected p can be kept in global store as p [c] .

An alternative to this method would be to use the method of the first embodiment, except that each point of call, 1, 2 . . . k, to a multi-caller function f may (optionally) use different values for s[f] and e[f], say s[f][1], s[f][2], . . . s[f][k] and e[f][1], e[f][2], . . . e[f][k]. The function f would then check that wisb is equal to one of the s[f][i], finally returning the matching e[f][i]. Any protected function called by f would potentially also have multiple associations, and in the end such a method might become unmanageable as well as inefficient.

### THIRD EMBODIMENT

A third embodiment of the present invention will now be described.

The first two embodiments protect only whole function units. In both cases, the value for wisb inside a function m is s[m] for any source position following INIT[m], before TERM[m] and not during the set-up or clean-up around a function call. (This region is shown as stippled in FIG. 1). In the second embodiment, no protection was provided where a function f is called several times within the body of m; a faulty return from one call of f to a different call of f would not be detected.

In the third embodiment, function bodies are considered to be segmented into smaller regions, and each region is protected in a way similar to protecting a whole function.

It is possible to apply this embodiment to “monolithic” code which is not split up into functions. In this case, it is considered that there is just one function, and it encompasses the whole of the code. There will be one entry point (the program start), and possibly no exit point (if the program is non-terminating).

For the purposed of explanation, and in order to provide a method that can be applied generally in any situation, a simplified language consisting of the following elements, defined recursively, will be considered:

A “code segment” S is any one of:
A
   atomic statement, such as an assignment or a call to an (unprotected) function, or an empty statement (denoted “{ }”).
F
   a statement like an atomic statement but in which there is exactly one call to a protected function, and that function name is retrieved using the notation FUNC(F). For example, FUNC(“a=3+f(x*g(y))”) is equal to “f” (assuming f is protected and g is not).
D: S
   a segment S with some local variables D declared, whose scope is S.
S1; S2
   a compound of two segments S1 and S2 executed sequentially, S1 first.
while (E) S1
   a looping construct in which the segment S1 is repeated while the expression E is true. E must not contain a call to a protected function.
if E S1 S2
   a conditional construct which evaluates E and then performs S1 if F is true, S2 if E is false. E must not contain a call to a protected function.
return E
   a return statement which exits from the current function and returns to the caller with the optional return value E. E must not contain a call to a protected function.

Brackets { . . . } are used for grouping terms which would otherwise be ambiguous.

A “program”, P, is a set of definitions of global variables and functions. Each function f has a body, B (f), which is a code segment. There is a “main” function MAIN (P) which is the entry point for P.

It is further assumed, for simple reasons, that P does not mention the variable name “wisb”. If it does, then the name should be replaced throughout by a new name. It will be readily understood by those skilled in the art that any real world program can be reduced mechanically to one in this form. The simplification provided by this reduced form is not essential, but it makes the description of the transformation much simpler.

More importantly, using the teaching provided herein, it will be clear to those skilled in the art how to apply the transformation to the original program, without explicitly using the reduced form as an intermediate.

Let a, b, c, d be meta variables standing for integer constants.

Define #a to be the optional statement “_assert (wisb==a)”. It is optional in the sense that the transform may insert the statement as given, or leave it out. Both are considered acceptable instantiations of the transform, with the proviso as before that if all the assertions are left out then there is no protection left.

Define T(a,b) to be the segment “#a; wisb+=b−a; #b” provided a is not equal to b, and “#a” if a is equal to b.

Given constants a and b, a transformation a<<S>>b is defined on a segment S as follows, by recursion on the structure of S:

a<<A>>b=#a; A; T(a,b);
a<<F>>b=#a; T(a,s[FUNC(F)]); F; T(e[FUNC(F)], b)
a<<D:S>>b=D: {#a; a<<S2>>b}
a<<S1;S2>>b=#a; a<<S1>>c; c<<S2>>b
for some new random value c
   a<<while(E) S>>b=#a; while(E) {T(a,c); c<<S>>a}; T(a,b)
for some new random value c
   a<<if(E) S1 S2>>b=#a; if(E) {T(a,c); c<<S1>>b} {T(a,d); d<S2>>b}
for some new random pair of values c, d
   a<<return E>>b=T(a, e[f]); return E
where f is the enclosing function

Define B (f, S), the transform of the body S of a function f:

### B(f,S)=s[F]<<S>>e[f]

for some new random pair of values s[f], e[f]

A transformation P′ of a program P is defined as follows. Starting with P, add definitions for the random constants s[f] and e[f] for each protected function f defined in P. Add the global definition for wisb, initialised to the value [MAIN (P)]. For each protected function f in P, replace the body S of f by B(S). For each unprotected function g in P, whenever g calls a protected function f insert the statement wisb=s[f] just before the call to f. Call the result P′.

The definition contains a large amount of choice, in the decision to insert the tests #a, and in the choice of constants. If every #a is taken as a compulsory assertion and every constant is chosen to be a new one, then the transformed program will be rather large, but very protected.

It is allowable to replace consecutive statements “T(a,b); T(b,c)” by the single T(a,c) to reduce program size (and possibly with an increase of security).

If desired, the random constants c and d can be chosen to be the same as other random constants, then many of the T (a,b) statements would vanish (according to the definition of T when a is equal to b).

An example will now be presented. Suppose this is the unprotected code:

```
main( ) {
    x = 1;
    y = 2;
    return;
}
```

This is transformed initially as follows:

| int wisb = s[main]; // global | |
|---|---|
| const A=84756387, B=48976230; // random constants | |
| const sMain=45732576, eMain=2098573; | |
| main ( ) { | |
| _assert(wisb == sMain); //optional | |
| x = 1; | |
| _assert(wisb == sMain); //optional | |
| wisb += A − sMain; | |
| _assert(wisb == A); //optional | |
| y = 2; | |
| _assert(wisb == A); //optional | |
| wisb += B − A; | |
| _assert(wisb == B); //optional | |
| wisb += eMain − B; | |
| _assert(wisb == eMain); //optional | |
| return; | |
| _assert(wisb == B); | // optional: |
| | // note: cannot reach here |
| } | |

With some optional _asserts removed, this becomes:

```
int wisb = s[main]; // global
const A=84756387, B=48976230; // random constants
const sMain=45732576, eMain=2098573;
main ( ) {
    _assert(wisb == sMain); //optional
    x = 1;
    wisb += A − sMain;
    _assert(wisb == A); //optional
    y = 2;
    wisb += B − A;
    wisb += eMain − B;
    _assert(wisb == eMain); //optional
    return;
}
```

Combining wisb increments gives:

```
int wisb = s[main]; // global
const A=84756387;  // random constants
const sMain=45732576, eMain=2098573;
main ( ) {
    _assert(wisb == sMain); //optional
    x = 1;
    wisb += A − sMain;
    _assert(wisb == A); //optional
    y = 2;
    wisb += eMain − A;
    _assert(wisb == eMain); //optional
    return;
}
```

If A had been chosen to be the same as s[main], it could have been:

```
int wisb = s[main]; // global
const sMain=45732576, eMain=2098573;
main ( ) {
    _assert(wisb == sMain); //optional
    x = 1;
    y = 2;
    wisb += eMain − sMain;
    _assert(wisb == eMain); //optional
    return;
}
```

It is to be noted that the constants sMain and eMain would preferably be built into the code by the compiler, rather than stored in and retrieved from memory during execution.

### FOURTH EMBODIMENT

In a fourth embodiment of the present invention, protection is added against multi-caller functions returning to the wrong caller due to a fault. In the third embodiment, each caller of function f expects wisb to be set to e[f] on its return, so wisb on its own is not enough to detect this kind of error.

The transformation of the third embodiment is modified, in a corresponding manner as the second embodiment was derived from the first embodiment, as follows.

Add an extra global variable path. Modify the definition of _{—<}_>>_by replacing the clause for protected function call:

a<<F>>b =

```
#a;
declare p:
{
  p = path; path+=R;
  T(a,s[FUNC(F)]); F; T(e[FUNC(F)], b);
  _assert(path − p == R); path−=R;
}
```

Here p is a new variable name not used in F.

Taking into account that path has the error propagation property like wisb, the above _assert statement can be treated as optional, and along with it the use of the local variable p, so long as an _assert statement is included at least somewhere in the program to ensure that path has the correct value at that point. This would result in a more efficient (faster, using less storage) execution. Treating these as optional would result in the following:

a<<F>>b =

```
#a;
{
  path+=R;
  T(a,s[FUNC(F)]); F; T(e[FUNC(F)], b);
  path−=R;
}
```

### FIFTH EMBODIMENT

Alternatively, all the protected function calls within a function body can share a single local variable p, and this can be considered a fifth embodiment of the present invention.

a<<F>>b =

#a; path+=R;
T(a,s[FUNC(F)]); F; T(e[FUNC(F)], b);
_assert(path − p == R); path−=R;

The function body transformation B is also modified:

B(f, S)=declare p: {p=path; s[f]<<S>>e[f]}
where p is a new variable name not mentioned in S.

### SIXTH EMBODIMENT

It is possible to use an embodiment of the present invention even if MAIN is not a protected function. Relaxing this restriction allows the case where an unprotected function, u, calls a protected function, p. This can be considered to be a sixth embodiment of the present invention.

Suppose the body of u contains the statement x p ( ). This could be replaced by:
declare tmp:
{tmp=wisb:
wisb=s[p];
x=p( );
#(e[p]);
wisb=tmp;}

If it is not possible for a protected function to call u (directly or indirectly via other calls) then it is not necessary to store the old value of wisb, or to restore it after calling p.

### General

FIG. 3 is a block diagram illustrating various stages in one possible scheme making use of an embodiment of the present invention. In a first stage S1, unprotected source code 2 is transformed into protected source code 4 using a security transformation procedure as described above. In a second stage S2, the protected source code is compiled and loaded into the target device 6. In a third stage S3, the compiled protected code is executed on the target device 6. During the third stage S3, a transient error or glitch attach occurs. This is detected by way of steps included in the compiled protected code as set out above, resulting in a hardware reset or other error handling routine S4 to be performed. FIG. 4 is an illustrative block diagram showing a device 10 programmed to execute a protected program according to an embodiment of the present invention, comprising a memory portion 12, a Central Processing Unit (CPU) 14, a Program Counter (PC) 16, an Input/Output Unit 18, and a Power Unit 20. FIG. 4 also illustrates examples of the various types of attack points on such a device.

Embodiments of the present invention have been described above with reference to source code written in (a simplified subset of) C, but it will be appreciated that an embodiment of the present invention can be implemented using any one of a wide range of procedural computer languages (including C++, Java, Pascal, Fortran, Basic, C#, Perl, etc.); an ordinarily skilled software engineer would readily be able to apply the teaching herein to other such languages. An embodiment of the present invention could also be implemented with or applied to lower-level code, which could be generated by a compiler, such as assembly language or machine code.

The checking can be implemented entirely in software, by transforming the original (unprotected) program in a systematic manner to obtain a protected program that realises the technical benefits described herein, such as protection against physical glitch type attacks. In this sense, the software transformation step alone results in a real and important technical benefit. The transform can be done manually, automatically, or some degree between these two extremes (for fine tuning, for example).

Since the checking is itself a software process, it should preferably exhibit resistance to the same kinds of attack as the program it is protecting.

To implement an embodiment of the present invention effectively, it is necessary to ensure that the C compiler does not over-optimise the scheme so that the security disappears altogether. It might be necessary to define wisb and path as “volatile” variables, which would force the compiler not to assume anything about their value, even after a direct assignment.

The constants s[ ], e [ ] should preferably be chosen randomly, to ensure that the distribution of the increments (e.g. e [main]−e[f]) is well spread. It would, however, be possible to derive s[f] and e[f] for example from the code entry point address of f, possibly using some kind of hashing technique (a cryptographic hash such as SHA-1 is not necessary here). For example, s[f]=(int)(f)/3; e[f]=(int)(f).

Although the check statements are individually optional, it will be appreciated that at least some must be present for the technique to be effective. The more there are, the sooner any attack will be detected. It may be a policy that checks immediately before critical operations (such as flash update or I/O) are not to be considered optional.

It will be appreciated that it is possible to make minor alterations to the transformations that do not essentially change the kind of protection offered, and these are to be considered as within the scope of the present invention as set out in the appended claims.

For example, the use of addition and subtraction to update wisb is not essential, and other arithmetic operations with similar properties could instead be used. One possibility would be to replace both addition and subtraction by an exclusive-or operation, so that the update would become of the form “wisb ̂=b̂a”, and similarly for manipulating the “path” variable.

The algebraic property required for this type of variable update to work is that:

A+(B−A)==B

for values A and B of the working datatype, which would usually but not necessarily be a subset of the integers. It is possible to perform such an update either by first computing an intermediate value “B−A”, and then adjusting the check value wisb based on that intermediate value, or by adjusting wisb separately with “+B” and “−A”. In the latter case, it is preferable to perform the “+B” adjustment first, since performing the “−A” adjustment first would normally result in wisb assuming a constant value (zero) between the pair of adjustments; this would mean that an unexpected jump from between one such pair of adjustments to between another such pair of adjustments might not be detected. It should also be noted that the addition and subtraction operations are essentially equivalent, since adding a negative value is the same as subtracting a positive value.

The symbols “+” and “−” can be replaced by any operations which have this property, for example:

A−(B$A)==B
(replacing “+” by “−” and “−” by “$”, defining B$A ==A−B (swapping the order of the operands)
   or:

ÂA(B̂A)==B
(replacing both “+” and “−” by “̂” (exclusive or))

In other words, the two operations would be required to stand in some kind of inverse relationship. Note that exclusive-or is its own inverse in this sense.

As described above, in one embodiment a single RAM variable is used as a check that control flow has not been interrupted. It is incremented by various amounts at different points in the code. If any increment is missed, the value will be wrong from then onwards. It can be verified frequently for fast detection, or less frequently if desired for efficiency.

An embodiment of the present invention has one or more of the following advantages:
Compactness: RAM requirement is very small, since in one embodiment a single variable is used to do the encoding rather than using, for example, one word of stack for each nested function call.
Simplicity: the transformation is simple, so may be assisted by macros or other automatic tools, or entirely automated.
Convenience: the method may be added to existing code without any structural changes. The scheme can also be applied to small pieces of code, without having to compute a global program flow state machine.
Flexibility: coverage can be as coarse or as fine as resources allow.
Efficiency: the inserted lines are short and fast to execute.
Effectiveness: it detects sections skipped over. It detects gross changes to control flow. Once an error is set it can be detected any time later (even if one or more check statements are skipped due to compound faults). (For example, U.S. Pat. No. 5,274,817 does not have the error propagation property.)

Possible applications of an embodiment of the present invention include passport chips, smart card devices and other such hardware security devices, and generally in any safety- and mission-critical secure devices.

The proposed method does not prevent all Program Counter glitch attacks. For example, it will not detect most attacks that cause a conditional branch instruction to be incorrectly taken (or not taken). It can miss faults that cause only a few instructions to be skipped. Therefore the implementer must in addition add (for example) multiple PIN checks and redundant calculations to check critical results.

It will be appreciated a program embodying the present invention can be stored on a computer-readable medium, or could, for example, be embodied in a signal such as a downloadable data signal provided from an Internet website. The appended claims are to be interpreted as covering a program by itself, or as a record on a carrier, or as a signal, or in any other form.

1. A method of protecting a program executing on a device at least to some extent from execution flow errors caused by physical disturbances, such as device failures and voltage spikes, that cause program execution to jump to an unexpected memory location, the executing program following an execution path that proceeds through a plurality of regions, and the method comprising:
providing a first check value at a randomly accessible memory location;
determining at least once in at least one region whether the first check value has an expected value for that region;
updating the first check value, as execution passes from a first region into a second region in which such a determination is made, so as to have a value expected in the second region; and
performing an error handling procedure if such a determination is negative.

2. A method as claimed in claim 1, comprising performing such a determining step before at least some operations of the program having a critical nature.

3. A method as claimed in claim 1, comprising performing such a determining step before at least some of the check value updating steps.

4. A method as claimed in claim 1, comprising performing such a determining step before at least some operations of the program that update a persistent storage of the device.

5. A method as claimed in claim 1, comprising performing such a determining step before at least some operations that cause data to be sent outside the device, or outside a protected area of the device.

6. A method as claimed in claim 1, comprising providing a second check value at a randomly accessible memory location, and, where a region comprises a functional unit of code called from a calling region and returning execution to a returning region, updating the second check value before execution passes out of the unit so as to have a final value expected for the unit, and determining whether the second check value has the expected final value after execution passes out of the unit and before execution returns to the returning region.

7. A method as claimed in claim 6, wherein the returning region is the same as the calling region.

8. A method as claimed in claim 6, wherein the second check value is the same as the first check value, using the same randomly accessible memory location, and comprising determining whether the second check value has the expected final value before the first check value is updated to have the value expected in the second region.

9. A method as claimed in claim 1, comprising, as execution passes into such a first region where such an updating step is performed before execution passes into such a second region, updating the first check value so as to have a value expected in the first region.

10. A method as claimed in claim 1, comprising updating the check value in a manner such that, once the check value assumes an unexpected value, it is likely to retain an unexpected value with subsequent such updates.

11. A method as claimed in claim 1, comprising updating the check value based on its expected value for the second region and its expected for the first region in a manner such that the updated check value has the expected value for the second region only if it has the expected value for the first region before the update.

12. A method as claimed in claim 11, comprising updating the check value by effectively applying a first adjustment derived from the expected value for the first region and a second adjustment derived from the expected value for the second region, the first adjustment using an operator that has an inverse relationship to that used for the second adjustment.

13. A method as claimed in claim 12, comprising applying the first and second adjustments together by computing an intermediate value derived from the expected value for the first region and the expected value for the second region, and applying a single adjustment to the check value derived from the computed intermediate value.

14. A method as claimed in claim 13, wherein the intermediate value is precomputed.

15. A method as claimed in claim 12, comprising applying the first and second adjustments separately to the check value.

16. A method as claimed in claim 15, wherein the second adjustment is applied before the first adjustment.

17. A method as claimed in claim 12, wherein the operator for the first adjustment is a subtract operation and the operator for the second adjustment is an addition operation.

18. A method as claimed in claim 12, wherein the operator for the first adjustment is an exclusive-or operation and the operator for the second adjustment is an exclusive-or operation.

19. A method as claimed in claim 1, 2 or 3, wherein the respective expected values for at least some regions or functional units are retrieved directly from the program code.

20. A method as claimed in claim 1, comprising storing the respective expected values for at least some regions or functional units at different memory locations, and retrieving the expected value for a region or functional unit from the appropriate memory location when required.

21. A method as claimed in claim 1, wherein at least some expected values are random or pseudo random numbers.

22. A method as claimed in claim 1, wherein at least some expected values are derived from an entry point memory location of their corresponding respective regions or functional units.

23. A method as claimed in claim 22, comprising deriving the at least some expected values using a hashing technique.

24. A method as claimed in claim 1, comprising providing a third check value at a randomly accessible memory location, and, where a region comprises a functional unit of code called from a calling region and returning execution to the calling region, updating the third check value before execution passes into the functional unit so as to have a value related to that call, and determining, after execution returns from at least one such functional unit, whether the third check value has the value related to that call.

25. A method as claimed in claim 24, comprising performing the third check value determining step before execution passes back into the calling region.

26. A method as claimed in claim 24, comprising updating the third check value by applying an adjustment of an amount associated with that call, and determining whether the third check value retains the value related to that call after execution returns by determining whether reversing the adjustment by the same amount would return the third check value to its value prior to the pre-call adjustment.

27. A method as claimed in claim 24, comprising updating the third check value to return it to its value prior to the pre-call adjustment.

28. A method as claimed in claim 1, wherein the steps are carried out by instructions included in the program before execution.

29. A method as claimed in claim 1, wherein program execution is controlled by a Program Counter.

30. A method as claimed in claim 1, wherein the device comprises a secure device.

31. A method as claimed in claim 1, wherein the device comprises a smart card.

32. A method of protecting a program to be executed on a device at least to some extent from execution flow errors caused by physical disturbances, such as device failures and voltage spikes, that cause program execution to jump to an unexpected memory location, the program following when executed an execution path that proceeds through a plurality of regions, and the method comprising transforming the program so as to include the steps of:
providing a first check value at a randomly accessible memory location;
determining at least once in at least one region whether the first check value has an expected value for that region;
updating the first check value, as execution passes from a fast region into a second region in which such a determination is made, so as to have a value expected in the second region; and
performing an error handling procedure if such a determination is negative.

33. A method as claimed in claim 32, wherein the program is specified in a high level programming language such as the C programming language.

34. A method as claimed in claim 32, comprising compiling the program to produce machine code for execution directly by the device.

35. A device loaded with a program protected at least to some extent from execution flow errors caused by physical disturbances, such as device failures and voltage spikes, that cause program execution to jump to an unexpected memory location, the executing program following an execution path that proceeds through a plurality of regions, and the device comprising:
means for providing a first check value at a randomly accessible memory location;
means for determining at least once in at least one region whether the first check value has an expected value for that region;
means for updating the first check value, as execution passes from a first region into a second region in which such a determination is made, so as to have a value expected in the second region; and
means for performing an error handling procedure if such a determination is negative.

36. A program which, when run on a device, causes the device to carry out a method as claimed in claim 1.

37. A program which, when loaded into a device, causes the device to become one as claimed in claim 35.

38. A program as claimed in claim 36, carried on a carrier medium.

39. A program as claimed in claim 37, carried on a carrier medium.

40. A program as claimed in claim 38, wherein the carrier medium is a transmission medium or a storage medium.

41. A program as claimed in claim 39, wherein the carrier medium is a transmission medium or a storage medium.
